(19) United States
(12) Patent Application Publication
(10) Pub. No.: US 2024/0289006 A1
(43) Pub. Date: Aug. 29, 2024

(54) INTERFACE DISPLAYING METHOD AND APPARATUS, ELECTRONIC DEVICE, AND STORAGE MEDIUM

(71) Applicant: Beijing Zitiao Network Technology Co., Ltd., Beijing (CN)

(72) Inventor: Zilong WANG, Beijing (CN)

(21) Appl. No.: 18/572,671

(22) PCT Filed: Aug. 23, 2022
(86) PCT No.: PCT/CN2022/114204

§ 371 Date: Dec. 20, 2023

(30) Foreign Application Priority Data
Aug. 27, 2021 (CN) 202110996095.7

(51) Int. Cl. G06F 3/04845; G06F 9/451

(52) U.S. Cl. CPC G06F 3/04845; G06F 9/451

(57) ABSTRACT

Disclosed are an interface displaying method and apparatus, an electronic device and a storage medium. The method includes: receiving a first operation triggered on the basis of a display interface, the display interface including at least one target content associated with a preset subject, and the at least one target content being content published by a target user, and in response to the first preset operation, displaying a related interface of a group, wherein users in the group are associated with the target user.

### CROSS-REFERENCE TO RELATED APPLICATIONS

This application is the U.S. national phase of PCT Application No. PCT/CN2022/114204 filed on Aug. 23, 2022, which claims the priority of Chinese Patent Application No. 202110996095.7 filed on Aug. 27, 2021, whose title is “an interface displaying method and apparatus, an electronic device, and a storage medium”, and the entire content disclosed by the Chinese patent application is incorporated herein by reference as part of the present disclosure.

### TECHNICAL FIELD

The present disclosure relates to the field of information technology, and in particular, to an interface displaying method and apparatus, an electronic device, and a storage medium.

### BACKGROUND

With the continuous development of mobile network and mobile terminal technologies, social scenarios between people have become increasingly rich. For example, there may be a social scenario in which a group of users having the same interest or hobby gather together via a network. In this social scenario, users may share their own feelings on a certain interest subject.

### SUMMARY

In order to solve the above technical problems or partially solve the above technical problems, the present disclosure provides an interface displaying method and apparatus, an electronic device, and a storage medium, which realizes quick switching between a showing interface for target users to participate in a preset theme content and a related interface of a group.

In a first aspect, embodiments of the present disclosure provide a interface displaying method, the method comprises:
receiving a first preset operation triggered based on a showing interface, wherein the showing interface comprises at least one target content associated with a preset theme, and the at least one target content is a content posted by target users; and
displaying a related interface of a group in response to the first preset operation,
wherein users in the group are associated with the target users.

In a second aspect, embodiments of the present disclosure provide an interface displaying apparatus, the interface displaying apparatus comprises:
a first receiving module, configured to receive a first preset operation triggered based on a showing interface, wherein the showing interface comprises at least one target content associated with a preset theme, and the at least one target content is a content posted by target users; and
a display module, configured to display a related interface of a group in response to the first preset operation,
wherein users in the group are associated with the target users.

In a third aspect, embodiments of the present disclosure provide an electronic device, the electronic device comprises:
one or more processors; and
a storage unit, configured to store the one or more programs,
wherein the one or more programs, when executed by the one or more processors, cause the one or more processors to implement the interface displaying method as mentioned above.

In a fourth aspect, embodiments of the present disclosure provide a computer-readable storage medium, on which a computer program is stored, when the computer program executed by a processor, the interface displaying method as mentioned above is achieved.

### BRIEF DESCRIPTION OF THE DRAWINGS

The above and other features, advantages, and aspects of the embodiments of the present disclosure will become more apparent in conjunction with the attached drawings and with reference to the specific embodiments below. Throughout the drawings, identical or similar reference numbers indicate identical or similar elements. It should be understood that the drawings are schematic and that the members and elements are not necessarily drawn to scale.

FIG. 1 is a flowchart of an interface displaying method in an embodiment of the present disclosure;

FIG. 2 is a schematic diagram of a showing interface of a circle application in an embodiment of the present disclosure;

FIG. 3 is a schematic diagram of a creation interface of a group in an embodiment of the present disclosure;

FIG. 4 is a flowchart of an interface displaying method in an embodiment of the present disclosure;

FIG. 5 is a schematic diagram of a session interface of a group in an embodiment of the present disclosure;

FIG. 6 is a structural schematic diagram of an interface displaying apparatus in an embodiment of the present disclosure; and

FIG. 7 is a structural schematic diagram of an electronic device in an embodiment of the present disclosure.

### DETAILED DESCRIPTION

Embodiments of the present disclosure are described in more detail below with reference to the accompanying drawings. While some embodiments of the present disclosure are shown in the accompanying drawings, it should be understood that the present disclosure may be implemented in various forms and should not be interpreted as limited to the embodiments set forth herein, but rather are provided for a more thorough and complete understanding of the present disclosure. It should be understood that the drawings and embodiments of the present disclosure are for illustrative purposes only and are not intended to limit the protection scope of the present disclosure.

It should be understood that the various steps described in the method embodiments of the present disclosure may be performed in different sequences and in parallel. In addition, method embodiments may include additional steps and/or omit to execute the showing steps. The scope of the present disclosure is not limited in the respect.

The term “include” as used herein and its variations are open-ended including, i.e., “include but not limited to”. The term “base” means “base at least in part”. The term “one embodiment” means “at least one embodiment”; the term “another embodiment” means “at least one other embodiment”; the term “some embodiments” means “at least some embodiments”. Relating definitions of other terms are given in the description below.

It needs to be noted that “first”, “second” and other concepts mentioned in the present disclosure are used only to distinguish between different devices, modules or units and are not used to define the order or interdependence relationship of the functions performed by these devices, modules or units.

It needs to be noted that “one” and “more” mentioned in the present disclosure are schematic rather than restrictive and it should be understood by those skilled in the art that they should be understood to “one or more” unless expressly stated otherwise in the context.

The names of interacting messages or information between a plurality of devices in embodiment of the present disclosure are used for illustrative purposes only and are not used to limit the scope of such messages or information.

At present, for users in a social scenario, if a plurality of users want to communicate with one another, they can only communicate with one another based on an update shared by one user in their circle as a medium by commenting on the shared update and replying to comments. This results in low efficiency of communication between users.

In view of this, embodiments of the present disclosure provide an interface displaying method and apparatus, an electronic device, and a storage medium to realize quick switching between a showing interface for target users to participate in a preset theme content and a related interface of a group. The interface displaying method in the embodiments of the present disclosure is described below with reference to the accompanying drawings.

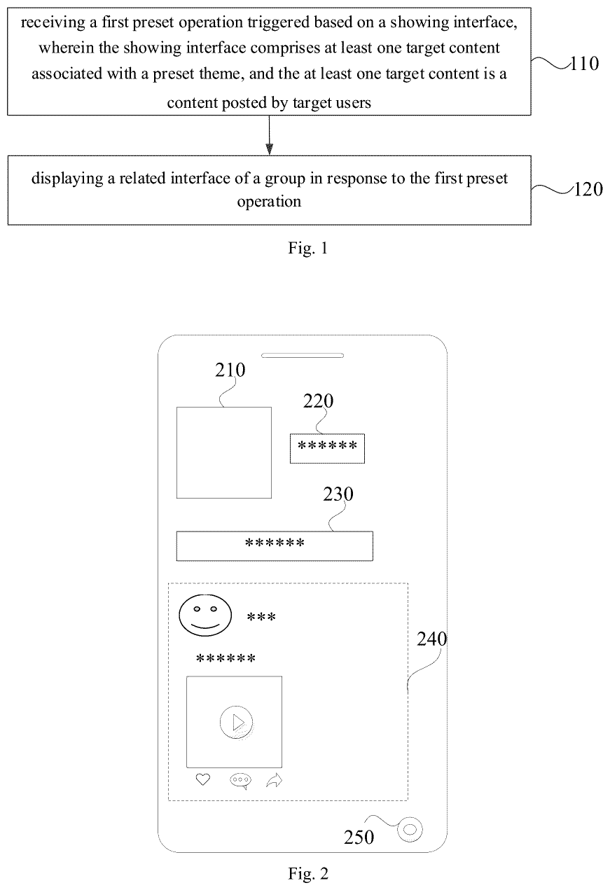

FIG. 1 is a flowchart of an interface displaying method in an embodiment of the present disclosure. The interface displaying method may be applied to a scenario of switching from a non-instant messaging interface to an instant messaging interface of a content consumption application, facilitating quick switching by a user between the non-instant messaging interface and the instant messaging interface. The interface displaying method may be performed by an interface displaying apparatus. The interface displaying apparatus may be implemented by using software and/or hardware and may be configured in an electronic device, e.g., a display terminal, specifically including but not limited to electronic devices with display screens such as a smart phone, a palmtop, a Pad, a portable wearable device, and a smart home device (e.g., a table lamp).

As shown in FIG. 1, the interface displaying method may include the following steps.

Step 110, receiving a first preset operation triggered based on a showing interface, where the showing interface includes at least one target content associated with a preset theme, and the at least one target content is a content posted by a target user.

Wherein, the showing interface may be specifically a showing interface for the target user to participate in a preset theme content. The target user may be a group of users having a same interest or hobby. The preset theme content may be a content related to the common interest or hobby of the target users. For example, the target users are a group of users enjoying keeping cats. The preset theme content may be a content related to keeping cats, such as sharing of experience of keeping cats and sharing of funny cat videos.

Exemplarily, a social scenario in which a group of users participate in a same theme content may be called a circle. The circle of each theme content usually has a moderator who is responsible for maintaining the circle, such as setting an avatar and a signature of the circle. With reference to a schematic diagram of a showing interface of a circle application shown in FIG. 2, an avatar 210, a nickname 220, and a signature 230 of the circle are usually displayed on the showing interface of the circle application. Members (i.e., the target users) of the circle may post dynamic information 240 (i.e., the target content) related to the theme content on the showing interface, and other members in the same circle may comment on, like or forward the dynamic formation. It needs to be noted that an ordinary user may become the target user only after meeting a preset condition. For example, the user needs to apply to join the circle, and then may have the authority of posting the target content associated with the preset theme on the showing interface or then may have the authority of participating in preset theme content interaction only after being accepted. The preset condition may specifically include a condition of joining the circle set by the moderator.

Therefore, on the showing interface of the existing circle application, the members of the circle may only communicate in a non-instant manner by commenting on posted dynamic information or replying to comments and cannot communicate in an instant manner. In view of this problem, in the interface switch solution provided in the present embodiment, with reference to FIG. 2, a first control 250 is displayed on the showing interface. The members of the circle may enter a related interface of a group by triggering the first control 250 to achieve the purpose of instant communication or may enter the related interface of the group by sliding the showing interface in a first direction. Sliding in the first direction may be, for example, sliding from left to right, sliding from right to left, or sliding from top to bottom, or sliding from bottom to top. That is, the first preset operation includes: a first operation of triggering a first control displayed on the showing interface; or, a second operation of sliding the showing interface in a first direction.

Step 120, displaying a related interface of a group in response to the first preset operation.

Wherein, users in the group are associated with the target users. Specifically, the users in the group are all of or a portion of the target users. That is, the users in the group are made up of the target users. In other words, the users in the group are the members of a circle. It will be understood that the group includes at least two users.

The related interface of the group includes at least one of a session interface of the group, a creation interface of the group, and a interface for applying to join the group.

Specifically, the related interface of the group may be the session interface of the group, and the group includes at least two users. It will be understood that on the session interface of the group, the users in the group may have an instant session, or an instant chat, i.e., a group chat.

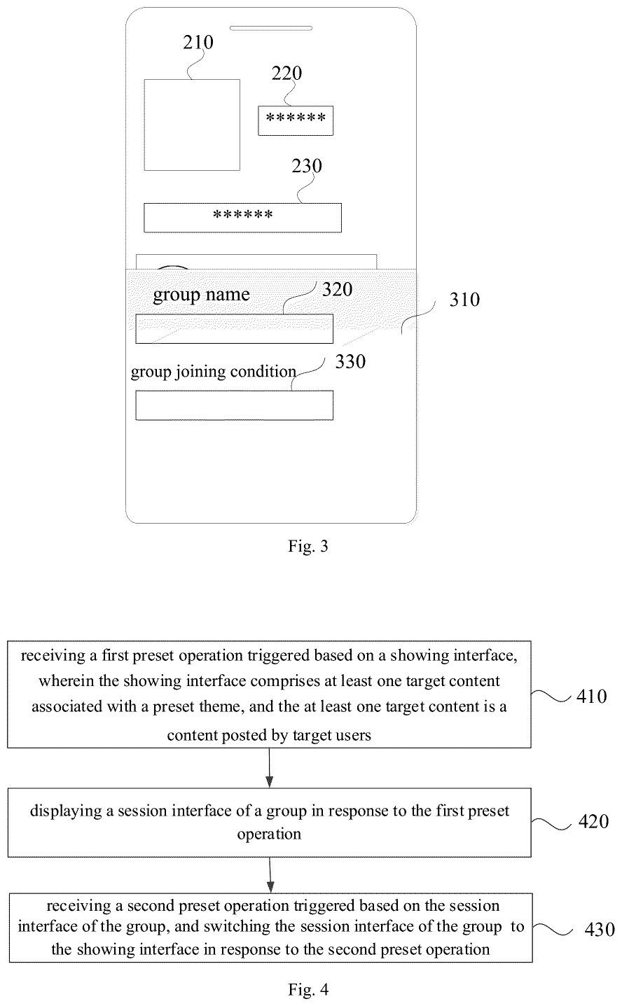

The related interface of the group may also be the creation interface of the group. For example, the creation interface of the group may be displayed in the form of a semi-popup. With reference to the schematic diagram of a creation interface of a group shown in FIG. 3, a group creation interface 310 is included. A setting box 320 for a group name, a setting box 330 for a group joining condition, and the like may be displayed on the group creation interface 310. A name of the group may be set based on the setting box 320 for a group name. The name of the group is set by default to a name of the circle, and a user who creates the group may edit the default group name. A group joining condition may be set based on the setting box 330 for a group joining condition. The group joining condition may be set as activation in the circle reaching a threshold for example. The activation in the circle may be quantified based on dimensions such as a frequency of a user posting dynamic information, a number of times of commenting, and a number of likes. After the group joining condition is set, the target users meeting the group joining condition are automatically added to the group. The group joining condition may also be automatically provided by a system. If the user makes no modification to the group joining condition, the condition automatically provided by a system is adopted as the group joining condition, and the target users meeting the group joining condition are controlled to join the group. The avatar of the group may also be set on the group creation interface 310. The avatar of the group is an avatar of the circle by default, and the user who creates the group may change the default avatar.

Recapitulatively, the related interface of the group is the creation interface of the group; and the displaying a related interface of a group in response to the first preset operation includes: displaying the creation interface of the group in response to the first preset operation, where the creation interface is configured to set associated information of the group. The associated information of the group includes at least one of a group avatar, a group name, and a group joining condition, etc.

Exemplarily, the displaying a related interface of a group in response to the first preset operation includes:
displaying the session interface of the group, the creation interface of the group, and the interface for applying to join the group in response to the first operation of triggering the first control displayed on the showing interface; or
displaying the session interface of the group, the creation interface of the group, and the interface for applying to join the group in response to the second operation of sliding the showing interface in the first direction.

According to the interface displaying method provided in the present embodiment, upon receiving the first preset operation acting on the showing interface, the related interface of the group is displayed, where the showing interface is the showing interface for the target users to participate in the preset theme content, and the users in the group are associated with the target users. Quick switching from the showing interface to the related interface of the group is realized. The related interface of the group includes the session interface of the group. The users in the session interface group of the group may have an instant chat. Quick switching from the showing interface that does not support instant messaging to the session interface of the group that supports instant messaging is realized. Moreover, the users in the group are made up of users participating in the preset theme content on the showing interface. Two social pathways are provided for the same group of users, and the two social pathways can be switched conveniently.

On the basis of the technical solutions of the foregoing embodiments, with reference to the flowchart of an interface displaying method shown in FIG. 4, the interface displaying method includes the following steps.

Step 410, receiving a first preset operation triggered based on a showing interface, where the showing interface includes at least one target content associated with a preset theme, and the at least one target content is a content posted by target users.

The first preset operation includes: a first operation of triggering a first control displayed on the showing interface; or, a second operation of sliding the showing interface along a first direction.

Step 420, displaying a session interface of a group in response to the first preset operation.

Users in the group are associated with the target users.

Step 430, receiving a second preset operation triggered based on the session interface of the group, and switching the session interface of the group to the showing interface in response to the second preset operation.

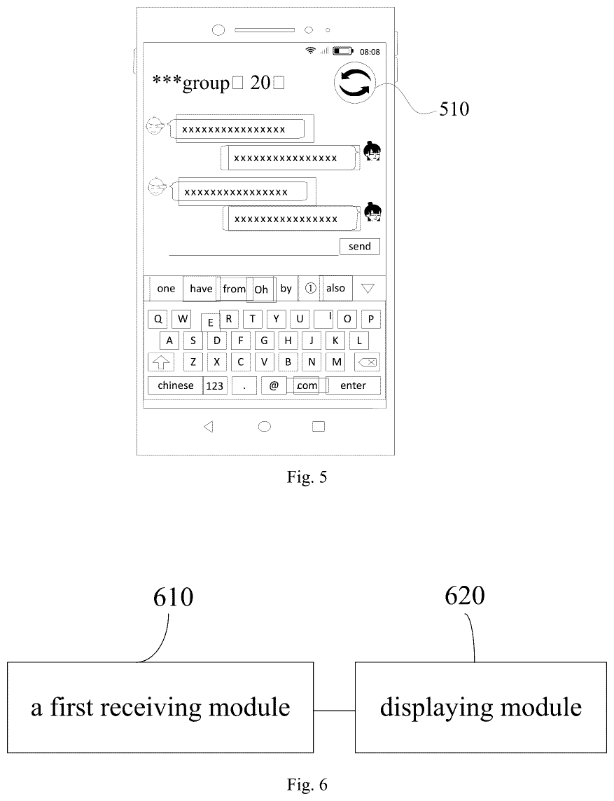

With reference to the schematic diagram of a session interface of a group shown in FIG. 5, a second control 510 is included. The users in the group may have an instant chat in the session interface. When a user triggers the second control 510, the session interface of the group is switched to the showing interface shown in FIG. 2.

The second preset operation includes: a third operation of triggering a second control displayed on the session interface; or, a fourth operation of sliding the session interface in a second direction.

Preferably, the second direction is opposite to the first direction. For example, the first direction is from left to right, and the second direction is from right to left. That is, the showing interface shown in FIG. 2 is slid from left to right to enter the session interface of the group shown in FIG. 5, and the session interface of the group shown in FIG. 5 is slid from right to left to return to the showing interface shown in FIG. 2. Quick switching between the showing interface and the session interface of the group is realized.

Further, guide information may also be displayed on the showing interface to guide a user to trigger the operation of sliding the showing interface in the first direction. The guide information may be a gesture imitation operation, i.e., a demonstration operation of sliding the showing interface from left to right by a virtual hand. Correspondingly, guide information is displayed on the session interface of the group to guide a user to trigger the operation of sliding the session interface in the second direction. For example, a demonstration operation of sliding the session interface from right to left by a virtual hand is displayed.

In some embodiments, if a target user is not a member of the group, when the target user slides the showing interface in the first direction (or triggers the first control displayed on the showing interface), the interface for applying to join the group is displayed. A group joining request is sent to an administrator of the group based on the interface for applying to join the group. When the administrator allows the target user to join the group, a related prompt message is displayed on the showing interface for the target user, and at this time, the target user may enter the session interface of the group when sliding the showing interface in the first direction.

FIG. 6 is a structural schematic diagram of an interface displaying apparatus in an embodiment of the present disclosure. As shown in FIG. 6, the interface displaying apparatus specifically includes a first receiving module 610 and a display module 620.

Wherein, the first receiving module 610 is configured to receive a first preset operation triggered based on a showing interface, where the showing interface includes at least one target content associated with a preset theme, and the at least one target content is a content posted by target users. The display module 620 is configured to display a related interface of a group in response to the first preset operation, where users in the group are associated with the target users.

Alternatively, the users in the group are all of or a part of the target users.

Alternatively, the related interface of the group includes at least one of a session interface of the group, a creation interface of the group, and an interface for applying to join the group.

Alternatively, the first preset operation includes:
a first operation of triggering a first control displayed on the showing interface; or, a second operation of sliding the showing interface in a first direction.

Alternatively, the related interface of the group is the creation interface of the group; and the display module 620 is specifically configured to display the creation interface of the group in response to the first preset operation, where the creation interface is configured to set associated information of the group.

Alternatively, the interface displaying apparatus further includes an addition module configured to add the target users meeting a preset condition to the group.

Alternatively, the related interface of the group is the session interface of the group; and the display module 620 is specifically configured to display the session interface of the group in response to the second operation of sliding the showing interface in the first direction.

Alternatively, the interface displaying apparatus further includes: a second receiving module configured to receive a second preset operation triggered based on the session interface of the group; and a switching module configured to switch the session interface of the group to the showing interface in response to the second preset operation.

Alternatively, the second preset operation includes:
a third operation of triggering a second control displayed on the session interface; or
a fourth operation of sliding the session interface in a second direction.

According to the interface displaying apparatus provided in embodiments of the present disclosure, upon receiving the first preset operation acting on the showing interface, the related interface of the group is displayed, where the showing interface is the showing interface for the target users to participate in the preset theme content, and the users in the group are associated with the target users. Quick switching from the showing interface to the related interface of the group is realized. The related interface of the group includes the session interface of the group. The users in the session interface group of the group may have an instant chat. Quick switching from the showing interface that does not support instant messaging to the session interface of the group that supports instant messaging is realized. Moreover, the users in the group are made up of users participating in the preset theme content on the showing interface. Two social pathways are provided for the same group of users, and the two social pathways can be switched conveniently.

The interface displaying apparatus provided in the embodiment of the present disclosure may perform the steps of the interface displaying method provided in the embodiments of the present disclosure, and specific performing steps and beneficial effects are not redundantly described here.

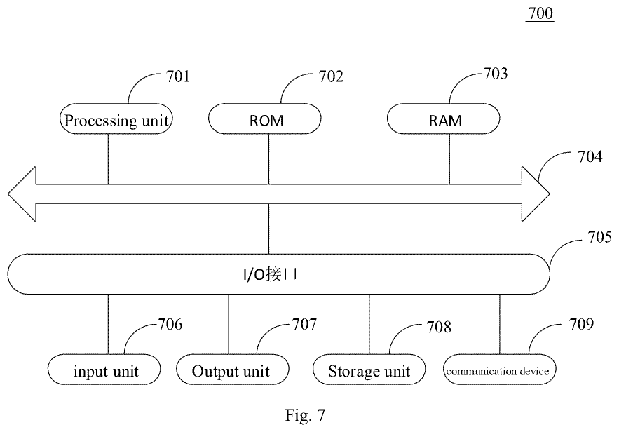

FIG. 7 is a structural schematic diagram of an electronic device in an embodiment of the present disclosure. The following description is made specifically with reference to FIG. 7 which is a structural schematic diagram of an electronic device 700 adapted to implement the embodiments of the present disclosure. The electronic device 700 in the embodiment of the present disclosure may include but not be limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device, and fixed terminals such as a digital TV, a desktop computer, and a smart home device. The electronic device shown in FIG. 7 is merely an example, and should not give any limitation to the functions and the usage range of the embodiments of the present disclosure.

As shown in FIG. 7, the electronic device 700 may include a processing unit (e.g., a central processing unit, or a graphics processing unit) 701, which may perform various suitable actions and processing according to a program stored in a read-only memory (ROM) 702 or a program loaded from a storage unit 708 into a random access memory (RAM) 703 to implement the method described in the embodiments of the present disclosure. The RAM 703 further stores various programs and data required for operations of the electronic device 700. The processing unit 701, the ROM 702, and the RAM 703 are interconnected by means of a bus 704. An input/output (I/O) interface 705 is also connected to the bus 704.

Usually, the following devices may be connected to the I/O interface 705: an input unit 706 including, for example, a touch screen, a touch pad, a keyboard, a mouse, a camera, a microphone, an accelerometer, and a gyroscope; an output unit 707 including, for example, a liquid crystal display (LCD), a loudspeaker, and a vibrator; a storage unit 708 including, for example, a magnetic tape and a hard disk; and a interface displaying apparatus 709. The interface displaying apparatus 709 may allow the electronic device 700 to switch an interface with other devices wirelessly or in a wired way to exchange data. While FIG. 7 illustrates the electronic device 700 having various units, it is to be understood that all the illustrated units are not necessarily implemented or included. More or less units may be implemented or included alternatively.

Particularly, according to the embodiments of the present disclosure, the process described above with reference to the flowchart may be implemented as a computer software program. For example, an embodiment of the present disclosure includes a computer program product, which includes a computer program carried on a non-transitory computer-readable medium. The computer program includes a program code for performing the interface displaying method shown in the flowchart to implement the interface displaying method described above. In such an embodiment, the computer program may be downloaded online through the interface displaying apparatus 709 and installed, or installed from the storage unit 708, or installed from the ROM 702. When the computer program is executed by the processing unit 701, the functions defined in the method of the embodiments of the present disclosure are executed.

It needs to be noted that the computer-readable medium described above in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination of them. More specific examples of the computer-readable storage medium may include but not be limited to: an electrical connection with one or more wires, a portable computer disk, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries thereon a computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable storage medium may send, propagate or transmit a program used by or in combination with an instruction execution system, apparatus or device. The program code included on the computer-readable medium may be transmitted by using any suitable medium, including but not limited to an electric wire, a fiber-optic cable, radio frequency (RF) and the like, or any appropriate combination thereof.

In some implementations, a client and a server may switch interfaces by means of any network protocol currently known or to be developed in future such as HyperText Transfer Protocol (HTTP), and may achieve interconnection with digital interface switching data in any form or any medium (e.g., an interface switching network). Examples of the interface switching network include a local area network (LAN), a wide area network (WAN), an Internet work (e.g., the Internet), a peer-to-peer network (e.g., ad hoc peer-to-peer network), and any network currently known or to be developed in future.

The above-mentioned computer-readable medium may be included in the electronic device described above, or may exist alone without being assembled with the electronic device.

The above-mentioned computer-readable medium may carry one or more programs which, when executed by the electronic device, cause the electronic device to:
receive a first preset operation triggered based on a showing interface, where the showing interface includes at least one target content associated with a preset theme, and the at least one target content is a content posted by target users; and display a related interface of a group in response to the first preset operation, where users in the group are associated with the target users.

Optionally, when the one or more programs are executed by the electronic device, the electronic device may further perform other steps described in the foregoing embodiments.

A computer program code for performing the operations in the present disclosure may be written in one or more programming languages or a combination thereof. The programming languages include but are not limited to device oriented programming languages, such as Java, Smalltalk, and C++, and conventional procedural programming languages, such as C or similar programming languages. The program code can be executed fully on a user's computer, executed partially on a user's computer, executed as an independent software package, executed partially on a user's computer and partially on a remote computer, or executed fully on a remote computer or a server. In a circumstance in which a remote computer is involved, the remote computer may be connected to a user computer via any type of network, including a local area network (LAN) or a wide area network (WAN), or may be connected to an external computer (for example, connected via the Internet by using an Internet service provider).

The flowcharts and block diagrams in the accompanying drawings illustrate system architectures, functions and operations that may be implemented by the system, method and computer program product according to the embodiments of the present disclosure. In this regard, each block in the flowcharts or block diagrams may represent a module, a program segment or a part of code, and the module, the program segment or the part of code includes one or more executable instructions for implementing specified logic functions. It should also be noted that in some alternative implementations, functions marked in the blocks may also take place in an order different from the order designated in the accompanying drawings. For example, two consecutive blocks can actually be executed substantially in parallel, and they may sometimes be executed in a reverse order, which depends on involved functions. It should also be noted that each block in the flowcharts and/or block diagrams and combinations of the blocks in the flowcharts and/or block diagrams may be implemented by a dedicated hardware-based system for executing specified functions or operations, or may be implemented by a combination of dedicated hardware and computer instructions.

Related units described in the embodiments of the present disclosure may be implemented by software, or may be implemented by hardware. The name of a unit does not constitute a limitation on the unit itself.

The functions described above herein may be performed at least in part by one or more hardware logic components. For example, exemplary types of hardware logic components that can be used without limitations include a field programmable gate array (FPGA), an application specific integrated circuit (ASIC), an application specific standard product (ASSP), a system on chip (SOC), a complex programmable logic device (CPLD), and the like.

In the context of the present disclosure, a machine-readable medium may be a tangible medium that may include or store a program for use by or in combination with an instruction execution system, apparatus or device. The machine-readable medium may be a machine-readable signal medium or a machine-readable storage medium. The machine-readable medium may include but be not limited to an electronic, magnetic, optical, electromagnetic, infrared, or semiconductor system, apparatus or device, or any appropriate combination thereof. More specific examples of the machine-readable storage medium may include an electrical connection with one or more wires, a portable computer disk, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination thereof.

According to one or more embodiments of the present disclosure, the present disclosure provides an interface displaying method including: receiving a first preset operation triggered based on a showing interface, where the showing interface includes at least one target content associated with a preset theme, and the at least one target content is a content posted by target users; and displaying a related interface of a group in response to the first preset operation, where users in the group are associated with the target users.

According to one or more embodiments of the present disclosure, in the interface displaying method provided in the present disclosure, alternatively, the users in the group are all of or a part of the target users.

According to one or more embodiments of the present disclosure, in the interface displaying method provided in the present disclosure, alternatively, the related interface of the group includes at least one of a session interface of the group, a creation interface of the group, and an interface for applying to join the group.

According to one or more embodiments of the present disclosure, in the interface displaying method provided in the present disclosure, alternatively, the first preset operation includes: a first operation of triggering a first control displayed on the showing interface; or, a second operation of sliding the showing interface in a first direction.

According to one or more embodiments of the present disclosure, in the interface displaying method provided in the present disclosure, alternatively, the related interface of the group is the creation interface of the group; and the displaying a related interface of a group in response to the first preset operation includes: displaying the creation interface of the group in response to the first preset operation, where the creation interface is configured to set associated information of the group.

According to one or more embodiments of the present disclosure, alternatively, the interface displaying method provided in the present disclosure further includes: adding the target users meeting a preset condition to the group.

According to one or more embodiments of the present disclosure, in the interface displaying method provided in the present disclosure, alternatively, the related interface of the group is the session interface of the group; and the displaying a related interface of a group in response to the first preset operation includes: displaying the session interface of the group in response to the second operation of sliding the showing interface in the first direction.

According to one or more embodiments of the present disclosure, alternatively, the interface displaying method provided in the present disclosure further includes: receiving a second preset operation triggered based on the session interface of the group; and switching from the session interface of the group to the showing interface in response to the second preset operation.

According to one or more embodiments of the present disclosure, in the interface displaying method provided in the present disclosure, alternatively, the second preset operation includes: a third operation of triggering a second control displayed on the session interface; or, a fourth operation of sliding the session interface in a second direction.

According to one or more embodiments of the present disclosure, the present disclosure provides an interface displaying apparatus including: a first receiving module configured to receive a first preset operation triggered based on a showing interface, where the showing interface includes at least one target content associated with a preset theme, and the at least one target content is a content posted by target users; and a display module configured to display a related interface of a group in response to the first preset operation, where users in the group are associated with the target users.

According to one or more embodiments of the present disclosure, in the interface displaying apparatus provided in the present disclosure, alternatively, the users in the group are all of or a part of the target users.

According to one or more embodiments of the present disclosure, in the interface displaying apparatus provided in the present disclosure, alternatively, the related interface of the group includes at least one of a session interface of the group, a creation interface of the group, and a interface for applying to join the group.

According to one or more embodiments of the present disclosure, in the interface displaying apparatus provided in the present disclosure, alternatively, the first preset operation includes: a first operation of triggering a first control displayed on the showing interface; or, a second operation of sliding the showing interface in a first direction.

According to one or more embodiments of the present disclosure, in the interface displaying apparatus provided in the present disclosure, alternatively, the related interface of the group is the creation interface of the group; and the display module is specifically configured to display the creation interface of the group in response to the first preset operation, where the creation interface is configured to set associated information of the group.

According to one or more embodiments of the present disclosure, alternatively, the interface displaying apparatus provided in the present disclosure further includes an addition module configured to add the target users meeting a preset condition to the group.

According to one or more embodiments, in the interface displaying apparatus provided in the present disclosure, alternatively, the related interface of the group is the session interface of the group; and the display module is specifically configured to display the session interface of the group in response to the second operation of sliding the showing interface in the first direction.

According to one or more embodiments of the present disclosure, alternatively, the interface displaying apparatus provided in the present disclosure further includes: a second receiving module configured to receive a second preset operation triggered based on the session interface of the group; and a switching module configured to switch from the session interface of the group to the showing interface in response to the second preset operation.

According to one or more embodiments, in the interface switching apparatus provided in the present disclosure, alternatively, the second preset operation includes: a third operation of triggering a second control displayed on the session interface; or, a fourth operation of sliding the session interface in a second direction.

According to one or more embodiments of the present disclosure, the present disclosure provides an electronic device, including:
one or more processors; and
a memory configured to store one or more programs,
where the one or more programs, when executed by the one or more processors, cause the one or more processors to implement any interface displaying method provided in the present disclosure.

According to one or more embodiments of the present disclosure, the present disclosure provides a computer-readable storage medium on which a computer program is stored and the computer program, when executed by a processor, implements any interface displaying method as provided in the present disclosure.

The present embodiment also provides a computer program product that includes a computer program or instruction that, when executed by a processor, implements the interface displaying method described above.

Compared with the prior art, the technical solution provided by the present embodiment has at least the following advantages:

In an interface displaying method provided by embodiments of the present disclosure, when receiving the first preset operation acting on the showing interface, the related interfaces of the group is displayed, the showing interface is the showing interface of the target user participating in the preset theme, the showing interface includes at least one target content associated with a preset theme, and the at least one target content is a content posted by target users r. The users in the group are associated with the target users to realize a quick switch from the showing interface to the related interfaces of the group.

The above description is only a better embodiment of the present disclosure and an explanation of the technical principles used. Those skilled in the art shall understand that the disclosure scope involved in the disclosure shall not be limited to technical solutions formed by a particular combination of the above technical features, but shall also cover other technical solutions formed by any combination of the above technical features or their equivalents without being separated from the above disclosed concept. For example, the technical solution formed by replacing the above features with the technical features disclosed in this disclosure (but not limited to) having similar functions.

In addition, although operations are described in a particular order, this should not be understood as requiring those operations to be performed in the showing particular order or in a sequential order. In certain circumstances, a plurality of masks and parallel processing may be advantageous. Similarly, although certain implementation details are included in the above discussion, these should not be interpreted as limiting the scope of this disclosure. Certain features described in the context of individual embodiments may also be implemented in combination in a single embodiment. Conversely, various features described in the context of a single embodiment may also be implemented in multiple embodiments individually or in any suitable sub-combination.

Although the subject matter has been described in language specific to structural features and/or method logical actions, it should be understood that the subject matter defined in the attached claims is not necessarily limited to the specific features or actions described above. Rather, the specific features and actions described above are merely example forms of implementing claims.

1. A interface displaying method, comprising:
receiving a first preset operation triggered based on a showing interface, wherein the showing interface comprises at least one target content associated with a preset theme, and the at least one target content is a content posted by target users; and
displaying a related interface of a group in response to the first preset operation,
wherein users in the group are associated with the target users.

2. The interface displaying method according to claim 1, wherein the users in the group are all or a portion of the target users.

3. The interface displaying method according to claim 1, wherein the related interface of the group includes at least one of a session interface of the group, a creation interface of the group, or an interface for applying to join the group.

4. The interface displaying method according to claim 1, wherein the first preset operation includes:
a first operation of triggering a first control displayed on the showing interface; or
a second operation of sliding the showing interface along a first direction.

5. The interface displaying method according to claim 3, wherein the related interface of the group is the creation interface of the group; and the displaying the related interface of a group in response to the first preset operation comprises:
displaying the creation interface of the group in response to the first preset operation, wherein the creation interface is configured to set associated information of the group.

6. The interface displaying method according to claim 5, further comprising:
adding the target user meeting a preset condition to the group.

7. The interface displaying method according to claim 3, wherein the related interface of the group is the session interface of the group; and the displaying the related interface of a group in response to the first preset operation comprises:
displaying the session interface of the group in response to the second operation of sliding the showing interface along the first direction.

8. The interface displaying method according to claim 7, further comprising:
receiving a second preset operation triggered based on the session interface of the group; and
switching the session interface of the group to the showing interface in response to the second preset operation.

9. The interface displaying method according to claim 8, wherein the second preset operation comprises:
a third operation of triggering a second control displayed on the session interface; or
a fourth operation of sliding the session interface in a second direction.

10. A interface displaying apparatus, comprising:
a first receiving module, configured to receive a first preset operation triggered based on a showing interface, wherein the showing interface comprises at least one target content associated with a preset theme, and the at least one target content is a content posted by target users; and
a display module, configured to display a related interface of a group in response to the first preset operation,
wherein users in the group are associated with the target users.

11. An electronic device, comprising:
one or more processors; and
a storage unit, configured to store the one or more programs,
wherein the one or more programs, when executed by the one or more processors, cause the one or more processors to implement the interface displaying method according to claim 1.

12. A computer-readable storage medium, on which a computer program is stored, when the computer program executed by a processor, the interface displaying method according to claim 1 is achieved.
